(19) United States
(12) Patent Application Publication
(10) Pub. No.: US 2015/0177702 A1
(43) Pub. Date: Jun. 25, 2015

(54) DEVICE AND METHOD TO SHOW RECIPIENT'S LOCAL TIME WITH REAL-TIME COMMUNICATION

(71) Applicants: Aidan Kehoe, Dublin (IE); Neeku Shamekhi, Dublin (IE)

(72) Inventors: Aidan Kehoe, Dublin (IE); Neeku Shamekhi, Dublin (IE)

(21) Appl. No.: 14/600,149

(22) Filed: Jan. 20, 2015

(51) Int. Cl. G04G 9/00

(52) U.S. Cl. CPC G04G 9/0076

(57) ABSTRACT

Time zone and day of the week differences can complicate international business and family communication. A device and a method are described for displaying the expected local time and day of the recipient when initiating real-time communication. For real-time communication by telephone, a device of the invention calculates the expected local time of the recipient using a mapping from phone number digit prefixes to time zone information. For real-time communication using video or text chat over the Internet Protocol, a device of the invention calculates the expected local time of the recipient using Internet geolocation services, together with a database mapping from locations to time zone information. In both cases, should the estimated local time of the recipient, or his or her day of the week, be likely to make contact socially problematic, the device of the invention prompts the initiator with this information, allowing the initiator to avoid socially problematic communication, e.g. phone calls in the small hours of the morning or on weekends.

### FIELD OF THE INVENTION

The present invention relates to a device and a method for display of the expected local time of the recipient when initiating real-time communication, in particular when initiating voice communication, text communication, video communication, or some combination of the three, with prompting for confirmation of initiation should the recipient's local time make communication unlikely to be appropriate.

### BACKGROUND OF THE INVENTION

When initiating real-time communication, e.g. when placing a telephone call, opening a network text chat session, or opening a network video chat session, the recipient's time zone may differ significantly from that of the originator.

This can arise with business communication, with many multinational companies having offices and facilities across the globe, e.g. in North America, Europe, East Asia, and Australasia [1] [2]. With family communication, this commonly arises in the context of emigration, e.g. of Iranians to California [3], or of Irish people to Australia [4].

Such real-time long-distance communication poses the problem that usual working hours, or usual leisure hours, at the originator's location may overlap only slightly, or not at all, with those at the recipient's location.

In order to avoid placing phone calls or initiating network text or video chat sessions when the recipient is likely to be sleeping, or when the recipient is unlikely to be able to respond (e.g. work calls during leisure hours, or leisure calls during work hours), people in regular contact typically learn the time zone difference and perform the appropriate mental arithmetic at the time of initiating such communication [5].

This is uncomplicated with some time zone differences, e.g. that between Western European Time and Central European Time for countries in the European Union. There is a one-hour difference between these time zones, with Western European Time, observed in Ireland, Britain and Portugal, among other countries, being one hour behind Central European Time, and with those same countries switching to Western European Summer Time when those EU countries using Central European Time switch to Central European Summer Time [6]. As such, the difference in time zones is one hour at all times of the year, so the mental arithmetic is undemanding.

Other time zone differences are not as simple. To illustrate this, the state of South Australia, with its capital Adelaide, has an offset 10.5 hours from Coordinated Universal Time (UTC, [7]) from the first Sunday in October until the first Sunday in April, and of 9.5 hours from UTC for the rest of the year. Those countries in the EU which use Western European Time in winter, among them Ireland, Britain and Portugal, have an offset of 0 hours from UTC from the last Sunday of October to the last Sunday of March, and of one hour from UTC for the rest of the year.

This means that at the beginning of March, the difference between Dublin and Adelaide is 10.5 hours; at the end of March, the difference is 9.5 hours, and at the end of April the difference is 8.5 hours. Later in the year, as daylight saving time ends in the northern hemisphere, and begins in the southern, there is a similar, confusing, progression in the differences in local time.

Calculation of these differences with mental arithmetic is error-prone, especially with larger differences meaning a day boundary is more likely to be involved. It is also subject to local laws changing observation of daylight saving time that may not be well-publicized in the originator's location [8].

In addition, time zone differences can come together with differences from country to country in when the weekend is observed, and many of the same issues arise. E.g. in Iran and Afghanistan, the weekend comprises Thursday evening and Friday[9, p. 374], while in other majority-Muslim countries, it often comprises Friday and Saturday. Calling businesses in these countries on Friday is much less likely to be useful than it would be when calling a western country.

With long-term emigration and regular contact, it is still practical to learn these differences. With more irregular contact, in particular while traveling, or with brief business phone calls, network text, or video chat sessions that are not repeated, or are only repeated at yearly intervals, it is impractical to learn the differences.

Telephone numbers and Internet Protocol (IP) addresses are both, in general, associated with geographical locations. This was inherent with the telephone from its inception, as each subscriber had a physical handset at a usual place associated with it.

As the Internet was deployed, the physical location associated with an Internet Protocol address was effectively hidden[10, p. 4], at least for peers as opposed to service providers, but with the widespread availability of geolocation services[11], this is no longer true.

Both telephone numbers and Internet addresses have cases where a given identifier will not correspond to an expected location. With telephony, number porting across geographic regions[12, p. 436] among other contexts, leads to this situation. Similarly, Internet services such as virtual private networks[13], where typically users appear to be accessing services from their workplace's network, while being physically located distant from that network, will mislead attempts at geolocation.

In the prior art, U.S. Pat. No. 8,654,615[14] describes a mechanical device to show the time in other time zones, with manual selection of the other time zones, and manual adjustment for daylight saving time. This is slightly less error-prone than mental arithmetic, but still places demands on the user's care and attention, and the mechanical device will often be distant from the means of real-time communication, e.g. from the phone or computer.

Also in the prior art, the Apple iPhone [15] has a World Clock function, allowing simultaneous display of the local time at a preconfigured list of locations.

This has the drawback that, in order to check the local time for a recipient when initiating communication with a recipient, the user must briefly switch to the World Clock, and only then to the phone or chat interface. It also has the drawback that, should the recipient's time zone not be configured among the locations listed, the user must configure this in the World Clock, then check the recipient's time, and only then switch to the phone or chat interface.

As of March 2014 the search engine Google™ responds to queries of the form “what time is it in location” with an information box giving the current local time at location, where location identifies a geographic location.

This has the drawback that the user must switch to a web browser, perform the search, assess the result, and then switch back to the phone or chat interface. If performing the search on a mobile phone, the user must additionally input the search using the mobile phone's text input, which can demand more time than it would on a desktop or laptop computer.

It furthermore has the drawback that extra work is necessary for localization. As of March 2014, the corresponding searches in German “wie spät ist es in location” and Persian “ [symbol] [symbol] [symbol] location [symbol] ”, again, where location identified a geographic location, did not produce the information box.

In Internet Relay Chat [16], one of the longest-lived Internet chat protocols, a common set of extensions named CTCP [17] includes the TIME command, which allows querying another client (a prospective chat partner) about the local time zone for that client.

This allows the implementation of the display of a recipient's expected local time before initiating a real-time chat. However, this protocol feature has the disadvantage that a peer has no obligation to supply this information. Indeed, at least one common IRC client refuses this by default[18].

In the past, real-time communications systems, in particular telephone systems, have had insufficient facilities available to make integrated calculation of a recipient's time zone possible. With the widespread deployment of telephone systems with integrated microchips, e.g as in U.S. Pat. No. 4,932,022[19], U.S. Pat. No. 6,047,054[20], time and time-zone information is more typically available at communication devices without further configuration.

Furthermore, the IANA Time Zone database[21], and similar computer-readable time zone databases, have only become available with the widespread deployment of digital technology. Such databases are compendia of time zone offsets from UTC[7], together with rules for recurring daylight saving time changes, and for one-off local time changes such as that which occurred on Nov. 7 2010, when Mercer County, North Dakota, switched from mountain to central time. They are the most practical means to calculate the expected local time at a remote location.

U.S. Pat. No. 8,666,043[22] describes a system and a method to provide geographic information when dialing a different geographic location. This information is loaded from the network, and stored in the telephone's memory.

This is limited to voice communication, and is further limited by the necessity to connect to a server to provide this information, where the server may be unavailable because of local restrictions (e.g. behind a corporate firewall), national restrictions (e.g. in Iran or China), or simply because the connection to the data network has not been configured. Further, should the recipient's local time differ from that of the originator, there is no automatic mechanism to determine if contact is likely to be socially problematic.

### OBJECTS OF THE INVENTION

It is an object of the present invention to describe a device and a method for displaying the expected local time of the recipient when initiating real-time communication, where this communication is by voice, by text, by video, or by some combination of all three, and where said initiating optionally requires confirmation at a prompt should the recipient's local time make communication unlikely to be appropriate.

This object is achieved through use of time zone information databases, in a preferred embodiment through use of the IANA Time Zone database[21], together with a mapping from recipient identifiers to time zone identifiers. It is further achieved through use of this mapping, with the recipient identifier in use, and with the current time at the originator (or, equivalently, with UTC and the offset of the current time from UTC) to determine the current local time for the recipient, and through displaying the current time at the recipient before initiating real-time communication.

Preferred embodiments of the invention are described in detail in the dependent claims.

### SUMMARY OF THE INVENTION

A device of the invention, in a first preferred embodiment, when used to initiate voice communication, and when the recipient identifier of the episode of communication comprises a phone number, can allow direct input of the recipient phone number.

The initial digits of a recipient phone number (with its international code) are usually enough to determine the expected time zone, especially for countries with a single international prefix and a single time zone. The device of the invention displays the expected time zone as soon as this can be determined.

This allows informing the user in good time, in particular, before finishing dialing, of any time differences that may make contact socially problematic. Once the entire phone number has been dialed, the device prompts for confirmation of initiation should the recipient's local time make communication unlikely to be appropriate.

The determination of the expected recipient time proceeds as follows:
1. The user initiating voice communication enters a first digit or leading ‘+’ sign.
2. If the entered character is a ‘+’ sign or could plausibly represent a prefix for a recipient in another time zone, the device continues determining the expected time.
3. Otherwise, if the entered character could not plausibly represent a recipient in another time zone, the device determines the expected local time of the recipient to be identical to the local time of the originator, and concludes the determination of the expected recipient time.
4. The user initiating voice communication enters a second digit.
5. If the ordered set of characters entered so far corresponds unambiguously to a single expected time zone, the device calculates the expected local time of the recipient given this, and concludes the determination of the expected recipient time.
6. The user initiating voice communication enters a further digit.
7. The device repeats step 5, continuing if necessary to 6 and looping until the user completes entry of a number or until an unambiguous time zone prefix is available.

This determination of the expected time zone is not limited to countries with a single international prefix and a single time zone. E.g. the North American Numbering Plan[12, p. 410] applies to multiple countries, with multiple time zones within at least two of those countries, and so local area codes will be used in determining the time zone.

With this first preferred embodiment, the mapping from recipient identifiers to time zones comprises a trie[23, p. 492] mapping from phone number prefixes to IANA time zones, where the phone numbers comprise the recipient identifiers.

A device of the invention, when used to initiate voice communication, and when the recipient identifier of the episode of communication comprises a phone number, can also allow selection of the recipient through some other means, e.g. from a list of names, or from a list of previously dialed or received calls.

This selection does not provide the same opportunity to display the recipient's local time. In this event, and in cases where there is a time difference that may make contact socially problematic, the device of the invention can display the recipient's local time briefly, for one to two seconds, before connecting, to allow the user to cancel dialing should that be inappropriate.

In a second preferred embodiment, a method of the invention is used to determine the expected time zone when initiating Internet text chat communication. This preferred embodiment uses Internet Relay Chat[16] for the chat protocol, though those skilled in the art will have little difficulty using the method of the invention with other Internet text chat protocols or with video chat protocols.

In a chat program of the second preferred embodiment, this chat program having a graphical user interface, a list of potential chat partners is displayed. This list can reflect partners from previous chat sessions, it can reflect individuals currently in multi-participant chat rooms, or it can reflect individuals pre-selected by the user.

To initiate communication, the user selects the recipient from the list. To calculate the expected local time for the recipient, the chat program of the invention proceeds as follows:
1. The recipient's software is queried using the CTCP TIME[17] command.
2. If the recipient's software supports the CTCP TIME command, the user's software attempts to parse the response, and determine the expected local time for the recipient.
3. If this succeeds, the user's chat program of the invention displays the expected local time at the recipient in some way, e.g. as a tooltip. If the recipient's local time makes communication unlikely to be appropriate, the chat program of the invention can display a confirmation prompt before going further with the chat communication.
4. If determination of the expected local time by means of the CTCP TIME command fails, then the chat program of the invention attempts to determine the local time using the IP address of the recipient.
5. The first step in this is to query a first geolocation service with the IP address of the recipient.
6. If this succeeds, the user's chat program of the invention continues to 8.
7. If querying a first geolocation service with the IP address of the recipient fails, the chat program of the invention can query a second geolocation service, and if this succeeds, continue to 8. Step 7 can be repeated for an arbitrary number of geolocation services.
8. Once the geographic location of the recipient's IP address has been determined, the associated time zone needs to be calculated. This is done using e.g. the shapefile distributed with the IANA Time Zone database[21], which gives vector information about borders frontiers between time zones worldwide.
9. With the time zone available, the expected recipient time is calculated, which is easily done given UTC or the originator's local time and the originator's local time offset from UTC.
10. Once this is done, the user's chat program of the invention proceeds to 3, and finishes the calculation of the expected local time for the recipient.

In the preferred embodiments of the invention, a preferred embodiment of a method to determine whether the communication is likely to be problematic, is used. This preferred embodiment of the method comprises the following steps:
1. The local time of the initiator is compared to the local time of the recipient.
2. If the two times are equal, no problematic time zone difference arises.
3. Otherwise, if the two times reflect the same calendar day, and if both times are within the working day (09.00-17.00), and if neither local time involves lunch (typically 12-14.00) no problematic time zone difference arises.
4. Otherwise, if the two times reflect different calendar days, and neither calendar day is a part of the local weekend, and if the other conditions in 3 hold, no problematic time zone difference arises.
5. Otherwise, if the two times reflect the same calendar day, and both times are within the evening, meaning in this preferred implementation the hours from 17.00-22.00, no problematic time zone difference arises.
6. Otherwise, if the two times reflect different calendar days, and one time is within the evening, while the other's calendar day is on the weekend, and the other's local time is during the evening or during what would otherwise be the working day, no problematic time zone difference arises.
7. Otherwise, if the two times reflect the same calendar day, and both times are at night, meaning in this preferred implementation from 22.00 to 08.00, it may be socially problematic to initiate communication, but this will not be for reasons of time zone difference.
8. Otherwise, a problematic time zone difference arises.

### BRIEF DESCRIPTION OF THE DRAWINGS

For a more complete understanding of the invention, reference is made to the following description and accompanying drawings, in which:

FIG. 1 shows a dial pad for a real-time voice communication device, in particular a telephone;

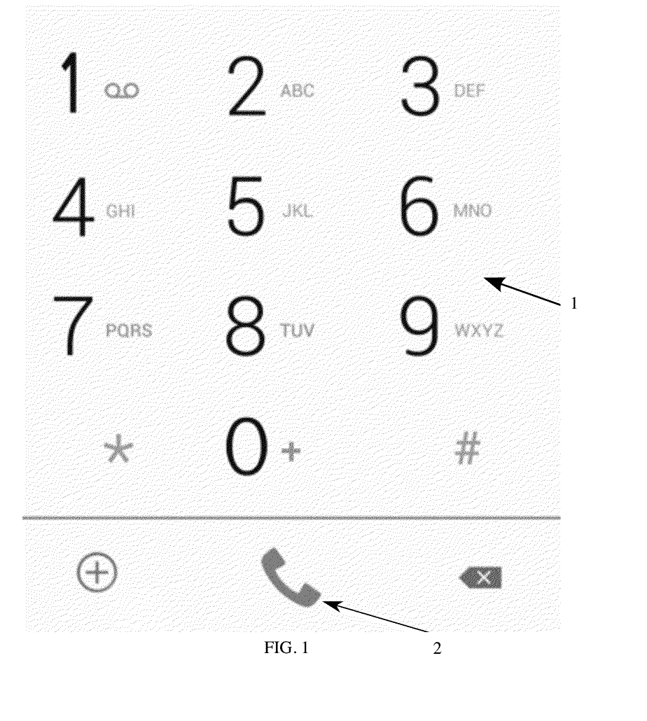

FIG. 2 is a diagram of the algorithm to determine recipient time with voice communication;

FIG. 3 shows a dial pad with a prompt in a context where a phone call is likely to be socially problematic;

FIG. 4 shows an Internet chat program, with three chat partners listed together with their activity status; and

FIG. 5 shows the Internet chat program of FIG. 4, with the mouse cursor having been clicked on one potential chat partner, and a tooltip showing said chat partner's location, time zone, day, and whether the current day is a work day.

Identical and identically-functioning components are denoted with the same reference numbers in the drawings.

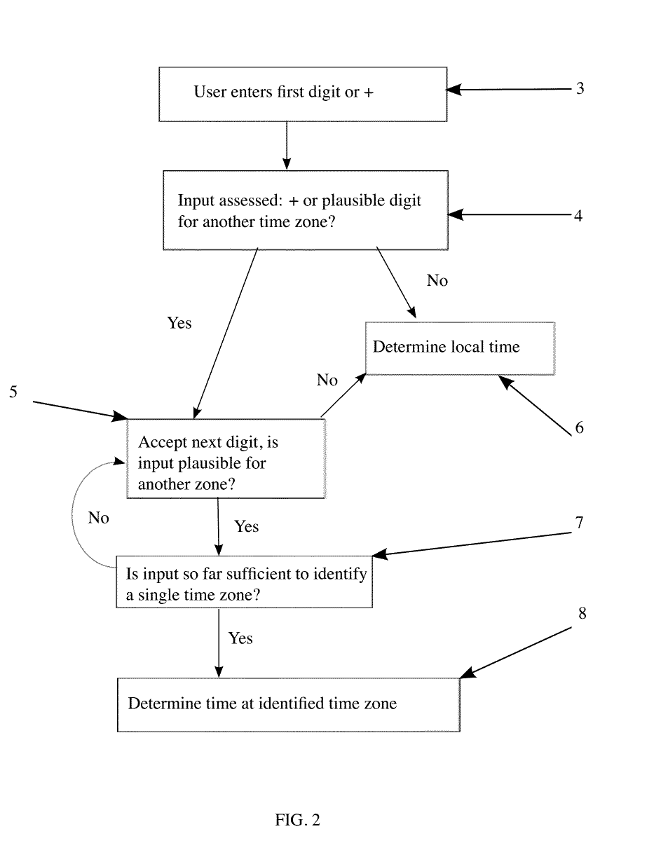

A device of the invention for voice communication, in particular a telephone, determines the local time of a recipient as shown in FIG. 2. The user enters a first character, using the dial pad[1], where that character can be a digit or ‘+’, for an international prefix. This is represented in FIG. 2 with Step [3].

Next, in Step [4], the device assesses this first character, and if it is ‘+’ or a plausible digit for another time zone (e.g. another digit used for international dialing, or if it could be the beginning of a national area code in another time zone), the determination of the expected recipient local time continues to Step [5]. If neither of these things holds, the method of the invention assumes the local time zone, represented by Step [6].

In Step [5], the device of the invention accepts input, and determines whether the entered character is a plausible digit for a reference to another time zone. Valid phone numbers do not have ‘+’ signs other than at the beginning, so this step does not have to consider ‘+’. When the nation in which the telephone is, has only one time zone, this step effectively consists of determining if the input so far could represent the beginning of an international call, and if so, determining which nation and time zone the destination represents.

Should the input so far be plausible for another time zone, the method of the invention moves to Step [7]. If the input is not plausible for another time zone, the method of the invention again assumes the local time zone, represented by Step [6].

In Step [7], the number so far entered is assessed, and if it is sufficient to identify a single time zone, the method of the invention determines that this time zone applies, represented by Step [8] in FIG. 2. Otherwise, the method loops, moving back to Step [5].

If the entire phone number has been entered, and if the user has attempted to establish the connection (e.g. by clicking the dial button[2]), the method of this embodiment of the invention assumes local time. If the map from phone number digit prefixes to time zones is complete, this should only arise for local calls within an organization or within a local area, and recipients of these calls typically share the time zone of the originator.

Should the expected local time of the recipient correspond to the local time of the originator, contact is unlikely to be socially problematic for reasons of time zone disjunction.

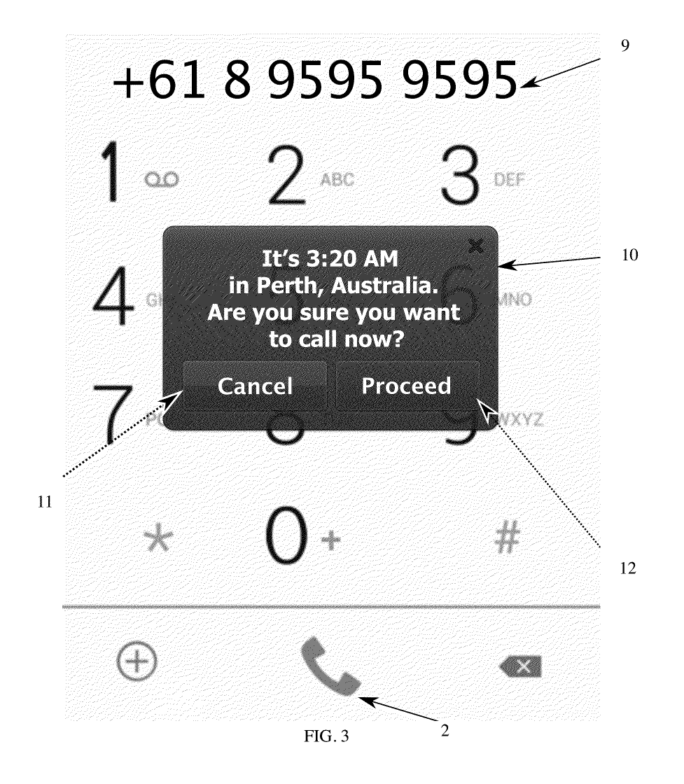

On the other hand, if time zone disjunction makes contact likely to be socially problematic, a device of the invention can confirmation from the user before initiating contact. This is shown in FIG. 3.

The user has entered a phone number [9] having Perth, Western Australia as its expected geographic location. The user is not in Australia, being, e.g. in Western Europe or North America, and the time zone difference means that contact is likely to be socially problematic.

The user has clicked the dial button[2], and the device of the invention has determined the recipient's local time and established that contact is likely to be socially problematic.

The device of the invention shows an alert, annotated in FIG. 3 with arrow [10], with the expected local time of the recipient, and offering the choice to proceed or to cancel the communication. The user can click or press the Cancel button[11] to stop the connection, or the Proceed button[12] to continue.

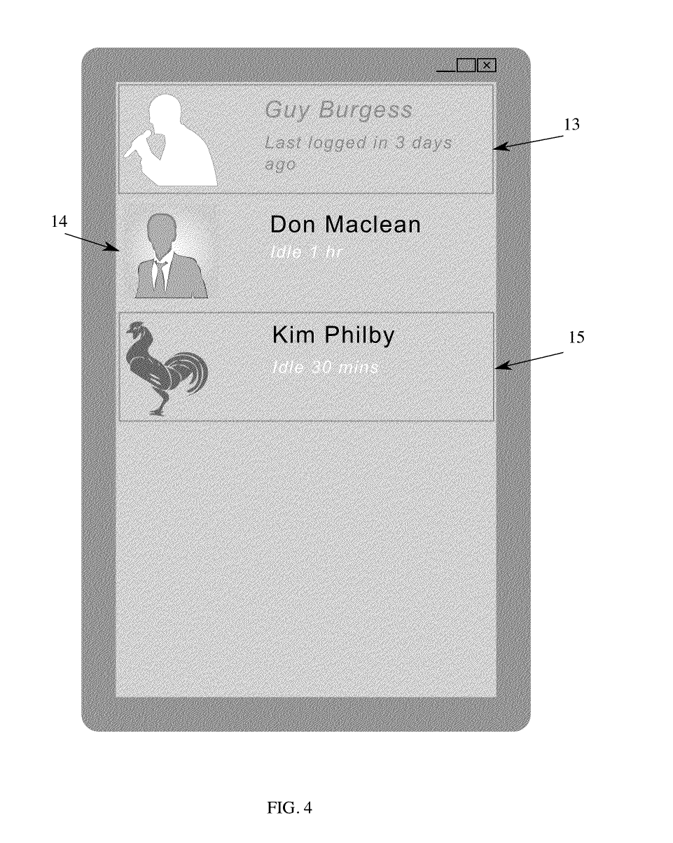

As we see in FIG. 4, a chat program of a preferred embodiment of the invention can have a window showing a list of known chat partners. In this figure, there are three listed chat partners, with associated names, icons, and details of their recent activity. The first [13] is grayed out, since he last logged in to the chat service three days ago. The next two [14], [15] are currently logged in, and their idle time is shown underneath their names.

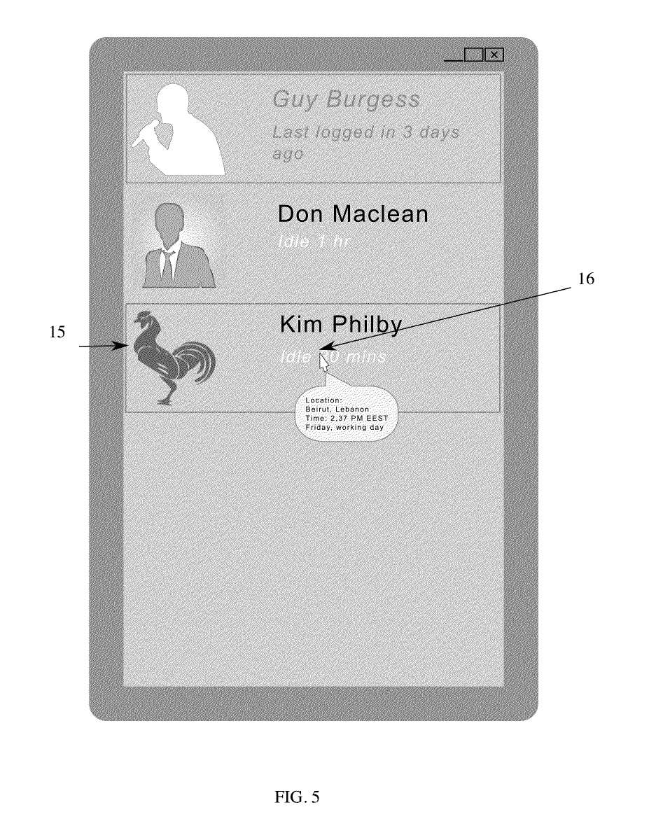

FIG. 5 shows the same window, but, as indicated by [16], the user has clicked on one of the chat partners[15], and the chat program of the invention displays, in response, a tooltip, a text popup showing the prospective chat partner's local time, the local weekday and whether that day is a work day or a weekend day.

### REFERENCES

[1] IBM Software. Berlitz taps intelligence of global workforce for best product quality. http://public.dhe.ibm.com/common/ssi/ecm/en/loc14245usen/LOC14245USEN.PDF, January 2011.
[2] Charlene Solomon. The challenges of working in virtual teams—virtual teams survey report—2010. http://www.rw-3.com/VTSReportv7.pdf, 2010.
[3] Neil MacFarquhar. Exiles in ‘Tehrangeles’ are split on Iran, May 9 2006. Available as http://www.nytimes.com/2006/05/09/us/09exiles.html.
[4] Irish Times staff. Destination in focus: Australia, Nov. 24 2011. Available as http://www.irishtimes.com/blogs/generationemigration/2011/11/24/destination-in-focus-australia/.
[5] Xiang Cao, Abigail Sellen, A. J. Bernheim Brush, David Kirk, Darren Edge, and Xianghua Ding. Understanding family communication across time zones. In Proceedings of the 2010 ACM Conference on Computer Supported Cooperative Work, CSCW '10, page 155-158, New York, N.Y., USA, 2010. ACM.
[6] European Commission, European Parliament, and Council of the European Union. Directive 2000/84/EC of the European Parliament and of the Council of 19 Jan. 2001 on Summer-time Arrangements. EU, 2001. Available at http://eur-lex.europa.eu/legal-content/EN/TXT/?uri=CELLAR:eb170453-93f3-4edb-a1ef-a4c46b64efc7.
[7] R A Nelson, D D McCarthy, S Malys, J Levine, B Guinot, H F Fliegel, R L Beard, and T R Bartholomew. The leap second: its history and possible future. Metrologia, 38(6):509, 2001.
[8] S. L. Macey. Encyclopedia of Time. Taylor & Francis, 2013.
[9] A. Burke. Iran. Country Guide Series. Lonely Planet, 2010.
[10] W. R. Stevens and G. R. Wright. TCP/IP Illustrated: The protocols. Addison-Wesley professional computing series. Addison-Wesley Pub. Co., 1994.
[11] Kevin F King. Geolocation and federalism on the internet: Cutting internet gambling's Gordian knot. Columbia Science and Technology Law Review, 11:41-75, 2010.
[12] D. Medhi. Network Routing: Algorithms, Protocols, and Architectures. The Morgan

Kaufmann Series in Networking. Elsevier Science, 2010.
[13] C. Scott, P. Wolfe, and M. Erwin. Virtual Private Networks. Animal Series. O'Reilly, 1999.
[14] W. C. Lin. Timer movement with a display for world time zones, Feb. 18 2014. U.S. Pat. No. 8,654,615.
[15] David Pogue. iPhone: The Missing Manual. The missing manual. O'Reilly Media, 2013.
[16] J. Oikarinen and D. Reed. Internet Relay Chat Protocol. RFC 1459 (Experimental), May 1993. Updated by RFCs 2810, 2811, 2812, 2813.
[17] Klaus Zeuge, Troy Rollo, and Ben Mesander. Client to client protocol (CTCP). Email dated August, 12:19, 1994.
[18] Ethan Blanton et al. IRC CTCP parsing code in pidgin, an open-source internet chat client, 2003-2014. Available at https://hg.pidgin.im/pidgin/main/annotate/551f4a5b3c33/src/protocols/irc/parse.c#1251.
[19] C. G. Keeney, G. L. Passon, R. J. Hagen, C. D. Foster, and F. J. Fritsch. Integrated voice and data telephone system, Jun. 5 1990. U.S. Pat. No. 4,932,022.
[20] J. A. Bayless, W. B. Black, G. L. Brannick, J. E. Fissel, G. W. Lee, L. M. Lloyd, L. P. Mason, A. L. Mathis, J. E. Steenbergen, M. R. Stoldt, et al. Computer telephone system, Apr. 4 2000. U.S. Pat. No. 6,047,054.
[21] Arthur David Olson, Paul Eggert, et al. IANA time zone database, 1986-present. Available at http://www.iana.org/time-zones.
[22] A. N. Ray. Telephone for providing information associated with a remote geographic location of a called party to a caller, Mar. 4 2014. U.S. Pat. No. 8,666,043.
[23] D. E. Knuth. The Art of Computer Programming: Sorting and searching: Addison-Wesley Series in Computer Science and Information Processing. Addison-Wesley, 1973.

What is claimed:

1. A device for real-time communication comprising:
a means for graphical display of information;
a clock with associated local time zone information;
a method for calculation of the expected local time of the recipient when initiating real-time communication;
a method to display said expected local time of the recipient using said means for graphical display;
a method for determining if the expected local time of the recipient is likely to be socially problematic because of disjunction of time zones;
a method to prompt for confirmation on initiating real-time communication should the expected local time of the recipient be likely to be socially problematic; and
a method for updating the time zone information of said device with other software updates.

2. The device of claim 1, where the device in question is a telephone and is primarily intended for real-time voice communication.

3. The device of claim 2 where the expected local time of the recipient is calculated using a correspondence between phone number digit prefixes and time zones stored in the device.

4. The device of claim 3 where said correspondence is stored in a memory- and time-efficient way using a trie.

5. The device of claim 1, where said device comprises a programmable computer having an Internet chat program, said chat program having a graphical user interface.

6. The device of claim 5, where said Internet chat program implements the Internet Relay Chat (IRC) protocol, and where said calculation of the expected local time of the recipient uses the CTCP TIME command.

7. The device of claim 5, where said Internet chat program uses a geolocation service with the recipient's IP address to determine the location of the recipient, and where said Internet chat program calculates the expected local time of the recipient using this location.

8. The device of claim 7, where the expected local time of the recipient is calculated using the recipient's location and the IANA Time Zone database or a similar computer-readable time zone database.

9. The device of claim 8, where said computer-readable time zone database is augmented with information about whether a given local time forms part of the weekend, and said method for determining if the expected local time of the recipient is likely to be problematic uses this information.

10. The device of claim 1, where said device is intended for simultaneous video and audio communication.

11. The device of claim 10 where, if the video telephony connection is done over the Internet Protocol, the determination of the expected recipient location and the expected local time of the recipient process as in claim 7.
